(19) United States
(12) Patent Application Publication
(10) Pub. No.: US 2008/0073871 A1
(43) Pub. Date: Mar. 27, 2008

(54) FOLDING TRANSPORT CART

(76) Inventor: Max Winkel, Glen Elder, KS (US)

Correspondence Address: THOMPSON & THOMPSON, P.A., P.O BOX 166, SCANDIA, KS, 66966, US

(21) Appl. No.: 11/861,385

(22) Filed: Sep. 26, 2007

Related U.S. Application Data
(60) Provisional application No. 60/847,794, filed on Sep. 27, 2006.

(51) Int. Cl. B62D 33/02; B60D 1/54

(52) U.S. Cl. 280/415.1; 280/491.3

(57) ABSTRACT

A folding transport cart includes a frame assembly having front and rear sections, and a hinge connecting the front and rear sections together for movement between a compact folded position for storage and an unfolded position for use. The hinge provides a transverse pivot axis between the front and rear sections above a floor of the cart. A pair of support wheels are attached on right and left sides of the frame assembly. A hitch tongue includes a vertical offset and is selectively attachable to the frame assembly to provide both low and high hitch towing positions. The hitch tongue can be reversed and attached in a stowed position for compact storage. A handle member is removably attached to the front end of the hitch tongue to facilitate manual towing. The handle member is removably nested within the hitch tongue or the rear section of the frame assembly for storage.

### RELATED APPLICATIONS

This application claims priority of U.S. Provisional Application No. 60/847,794 filed on Sep. 27, 2006. The content of this prior application is incorporated herein by reference.

### BACKGROUND OF THE INVENTION

1. Field of the Invention

The present invention relates to transport carts and trailers that can be folded into a compact configuration for storage, and also to convertible draw tongue and hitch assemblies for such carts and trailers.

2. Description of the Related Art

Transport carts are used to haul a wide variety of items, such as equipment for hunting and fishing, camping equipment, yard maintenance tools, farm tools and equipment, and various other recreational and work items. Transport carts come in many sizes, load capacities, and configurations. Some are built for road use with automobiles, while others are built for off-road use with tractors and ATVs.

Transport carts have been designed with folding or removable features to aid in the storage and portability of the cart. These carts are sometimes comprised of component parts that can be assembled together for use, and subsequently disassembled after use to minimize the size for carrying and storage. For example, U.S. Pat. No. 4,764,142 to Davis and U.S. Pat. No. 5,340,134 to Dodson both disclose trailers that can be disassembled and folded in a suitcase-like fashion for transporting and storage. Other transport carts have also been developed with folding features to facilitate transport and storage, including U.S. Patent Publication No. 2002/0195798 to James and U.S. Pat. No. 5,853,189 to Swartzlander.

Transport carts, particularly lightweight carts, often are moved manually. For example, maneuvering the carts in tight areas, backing the carts, or using the carts in areas where towing vehicles cannot go, may require users to manually pull and maneuver the carts. Conventional trailer hitches used to connect the tongue of a transport cart to a towing vehicle are often not conducive to gripping with the human hand. Various devices have been designed to provide handles for use with a tongue of a transport cart to facilitate manual movement. For example, the '798 publication to James and the '134 patent to Dodson both disclose handles coupled to a trailer tongue for manual towing.

The transport carts described above are presumably useful for their intended purposes and have solved some of the problems associated with transport trailers. However, there still exists a need for an improved transport cart that can be transformed into a compact configuration for storage, and also for an improved manual towing system for such carts.

### SUMMARY OF THE INVENTION

A folding transport cart according to the present invention includes a frame assembly having front and rear sections, and a hinge connecting the front and rear sections together for movement between a compact folded position for storage and an unfolded position for use. The hinge provides a transverse pivot axis between the front and rear sections above a floor of the cart. A pair of support wheels are attached on right and left sides of the frame assembly. A hitch tongue includes a vertical offset and is selectively attachable to the frame assembly to provide both low and high hitch towing positions. The hitch tongue can be reversed and attached in a stowed position for compact storage. A handle member is removably attached to the front end of the hitch tongue to facilitate manual towing. The handle member is removably nested within the hitch tongue or the rear section of the frame assembly for storage.

In accordance with an aspect of the present invention, a folding transport cart is provided, comprising a frame assembly having a front section, a rear section, and a hinge connecting the front and rear sections together for movement between a compact folded position for storage and an unfolded position for use; a pair of support wheels attached to the frame assembly and disposed on right and left sides of the frame assembly for supporting the frame assembly above the ground; and a hitch tongue removably attached to the front section of the frame assembly.

In accordance with another aspect of the present invention, a folding transport cart is provided, comprising: a frame assembly having a front section comprising a first platform, a rear section comprising a second platform, and a hinge connecting the front and rear sections together about a transverse axis disposed above the first and second platforms for movement between a compact folded position for storage and an unfolded position for use; a pair of support wheels attached to the frame assembly and disposed on right and left sides of the frame assembly for supporting the frame assembly above the ground; and a hitch tongue removably attached to the front section of the frame assembly.

In accordance with yet another aspect of the present invention, a transformable hitch assembly is provided, comprising: a hitch tongue having front and rear ends, a hitch structure provided at the front end for connecting to a towing vehicle, and a structure for removably connecting the hitch tongue to a transport cart; and a handle member removably attached to a pin opening at a front end of the hitch tongue to facilitate manual towing, wherein the hitch tongue has a first receptacle in its rear end in which the handle member can be stored when the handle member is not being used for manual towing.

Numerous other objects of the present invention will be apparent to those skilled in this art from the following description wherein there is shown and described an embodiment of the present invention, simply by way of illustration of one of the modes best suited to carry out the invention. As will be realized, the invention is capable of other different embodiments, and its several details are capable of modification in various obvious aspects without departing from the invention. Accordingly, the drawings and description should be regarded as illustrative in nature and not restrictive.

### BRIEF DESCRIPTION OF THE DRAWINGS

The present invention will become more clearly appreciated as the disclosure of the present invention is made with reference to the accompanying drawings. In the drawings:

FIG. 1 is a side elevation view of a folding transport cart according to the present invention, with a hitch tongue in a low hitch towing position.

FIG. 2 is a side elevation view of the folding transport cart, with the hitch tongue in a high hitch towing position and a handle member attached for manual towing.

FIG. 3 is a side elevation view of the folding transport cart in its compact, folded position for transport and storage.

FIG. 4 is a side elevation view of the folding transport cart in its folded position for vertical compact storage.

FIG. 5 is an exploded side elevation view of the main components of the folding transport cart of the present invention.

FIG. 6 is an exploded top plan view of the main components of the folding transport cart.

FIG. 7 is an exploded rear elevation view of the main components of the folding transport cart.

### DETAILED DESCRIPTION OF THE INVENTION

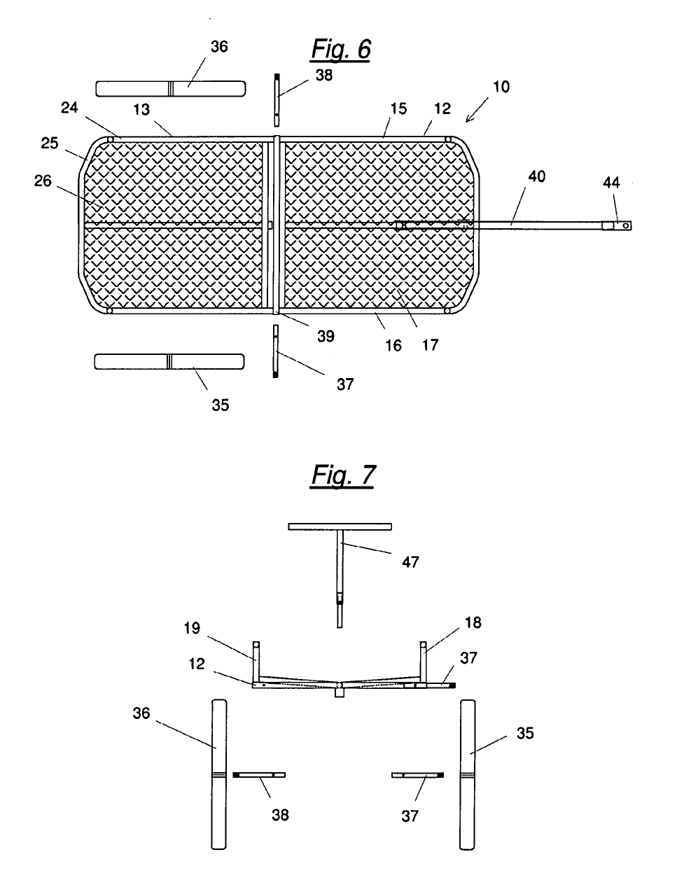

A folding transport cart 10 according to the present invention will now be described in detail with reference to FIGS. 1 to 7 of the accompanying drawings.

FIG. 1 shows the folding transport cart 10 of the present invention in an unfolded position and ready for use as a recreational or work cart. For example, the cart 10 can be used for hunting, fishing, camping, yard maintenance, farm use, and various other activities and jobs. As used herein, the phrase “transport cart” is intended to include trailers and other towable land vehicles.

The folding transport cart 10 includes a frame assembly 11 having a front section 12, a rear section 13, and a hinge 14 connecting the front and rear sections 12, 13 together.

The front section 12 comprises a first platform 15 comprising a tubular frame 16 covered by a floor 17 formed of expanded metal, sheet metal, or other suitable material. A first pair of upstanding walls 18, 19 are attached to the right and left sides of the first platform 15. Each of the upstanding walls 18, 19 comprises a tubular frame covered by a material 20, such as expanded metal or the like, similar to the floor 17 of the first platform 15. A first pair of receptacles 21, 22, such as channel members, are provided at the front ends of the upstanding walls 18, 19. The receptacles 21, 22 are used to receive the ends of a planar member B1, such as a 1″×8″ wooden board, to provide a removable upstanding front wall for the front section 12.

The rear section 13 of the frame assembly 11 has a construction similar to the front section 12. The rear section 13 comprises a second platform 24 comprising a tubular frame 25 covered by a floor 26 formed of expanded metal, sheet metal, or other suitable material. A second pair of upstanding walls 27, 28 are attached to the right and left sides of the second platform 24. Each of the upstanding walls 27, 28 comprises a tubular frame 29 covered by a material 30, such as expanded metal or the like, similar to the floor 26 of the second platform 24. A second pair of receptacles 31, 32 such as channel members, are provided at the rear ends of the upstanding walls 27, 28. The receptacles 31, 32 are used to receive the ends of a planar member B2, such as a 1″×8″ wooden board, to provide a removable upstanding rear wall for the rear section 13.

The hinge 14 is located at the top of the upstanding walls 18, 19, 27, 28 so that the front and rear sections 12, 13 are connected together for pivotal movement about a transverse axis disposed above the floor 17, 26 of the first and second platforms 15, 24. The front end 33 of the second platform 24 abuts against a rear end 34 of the first platform 15 when the frame assembly 11 is in its unfolded position shown in FIG. 1. The abutment between the first and second platforms 15, 24 is spaced below the hinge 14 to provide a means for preventing pivoting movement of the platforms 15, 24 past the point where the floor 26 of the second platform 24 is approximately coplanar with the floor 17 of the first platform 15 when the cart 10 is unfolded.

A pair of support wheels 35, 36 are attached to the front section 12 of the frame assembly 11 and are disposed on right and left sides of the frame assembly for supporting the frame assembly above the ground. As shown in FIGS. 5, 6 and 7, the wheels 35, 36 are mounted on respective spindles 37, 38 that are received in the ends of an axle tube 39 that extends along the bottom of the rear edge of the front section 12. The spindles 37, 38 can be removably attached within the axle tube 39 by pin connectors, or the spindles can be permanently attached by welding. The wheels 35, 36 are secured on the spindles 37, 38 using pins or other conventional means. The wheels 35, 36 can be spoked wheels with pneumatic tires similar to bicycle wheels, for example.

A hitch tongue 40 is removably attached to the front section 12 of the frame assembly 11 using a hitch receptacle 41 secured to the bottom of the front section 12. In the illustrated embodiment, the hitch receptacle 41 is a pair of short tubular members. In an alternative embodiment, the hitch receptacle 41 can be a channel-shaped member having an open bottom side. The hitch tongue 40 is received in the hitch receptacle 41 and removably attached using a pair of pin connectors 42, 43 inserted through aligned openings in the hitch receptacle 41 and the hitch tongue 40.

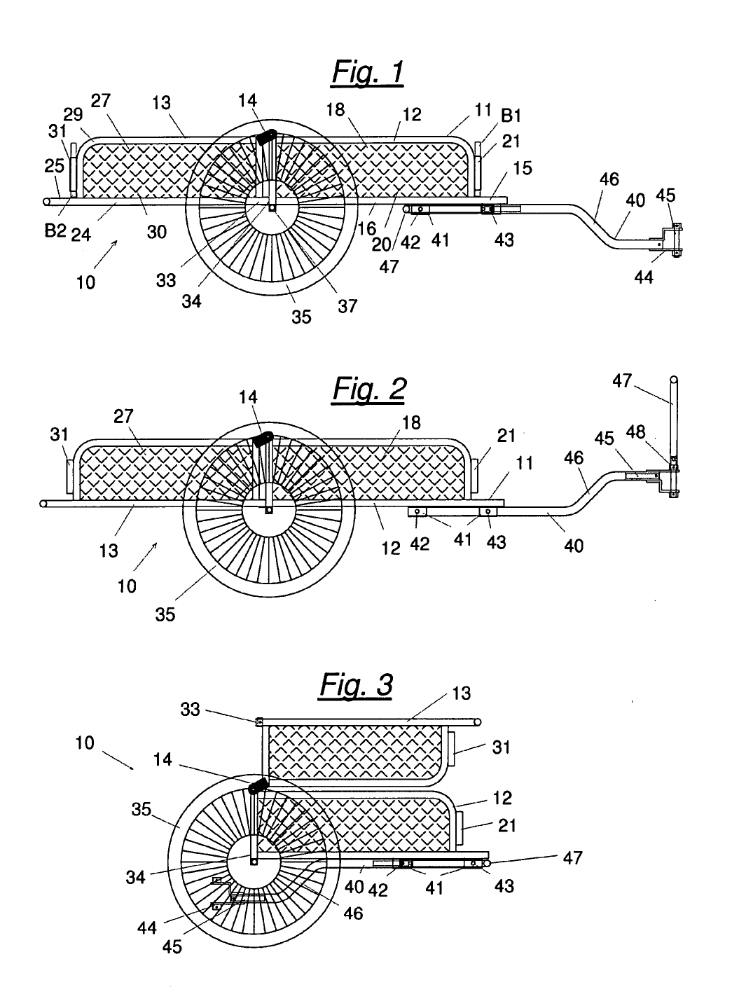

The hitch tongue 40 has a hitch structure 44 at its front end for connecting to a towing vehicle. In the illustrated embodiment, the hitch structure 44 comprises a yoke having upper and lower pin openings for receiving a hitch pin 45 for connecting to a towing vehicle. The hitch pin 45 is adapted to be carried in the tubular front end of the hitch tongue 40 when not in use, as shown in FIGS. 2, 3 and 4.

The hitch tongue 40 has a vertical offset portion 46 between its front and rear ends. The vertical offset portion 46 allows the hitch tongue 40 to be selectively positioned in low and high hitch towing positions. In FIG. 1, the hitch tongue 40 is shown in its low hitch towing position, and in FIG. 2 the hitch tongue 40 is shown in its high hitch towing position. By comparing FIGS. 1 and 2, it can be seen that the hitch structure 44 at the front end of the hitch tongue 40 is positioned higher in the high hitch towing position of FIG. 2 as compared to the low hitch towing position of FIG. 1.

The hitch tongue 40 can be easily switched between the low and high hitch towing positions shown in FIGS. 1 and 2. The hitch tongue 40 is detached from the front section 12 by removing the pin connectors 42, 43 from the hitch receptacle 41, and then sliding the hitch tongue 40 out of the hitch receptacle 41. The hitch tongue 40 is then rotated 180 degrees about its longitudinal axis, and then reinserted back into the hitch receptacle 41 and reconnected using the pin connectors 42, 43. In a preferred embodiment, the hitch tongue 40 is made of tubing having a rectangular-shaped cross section, which facilitates exact rotational positioning in 90 degree or 180 degree intervals.

As shown in FIG. 3, the hitch tongue 40 is also positionable into a third stowed position. In this position, the hitch tongue 40 is reversed such that the hitch structure 44 is positioned behind the front side of the front section 12 of the frame assembly 11. In the third stowed position, the hitch tongue 40 is kept in a compact position when the frame assembly 11 is in its compact folded position.

As shown in FIG. 2, a handle member 47 is removably attached to the pin openings of the hitch structure 44 at the front end of the hitch tongue 40. A connector pin 48 is inserted through aligned openings in the handle member 47 and the hitch structure 44 to keep the handle member 47 connected to the hitch tongue 40. The handle member 47 is a generally T-shaped member that provides a convenient handle and hand grip to facilitate manual towing.

The handle member 47 is made to nest within the rear end of the hitch tongue 40 when not in use to provide a compact storage configuration, as shown in FIG. 3. In this configuration, the opening in the handle member 47 is aligned with one of the openings in the hitch tongue 40 and the hitch receptacle 41. The handle member 47 is secured in its nested position using the same pin connector(s) 42 used to attach the hitch tongue 40 to the hitch receptacle 41, i.e., the pin connector 42 extends through aligned openings of the hitch receptacle 41, the hitch tongue 40, and the handle member 47.

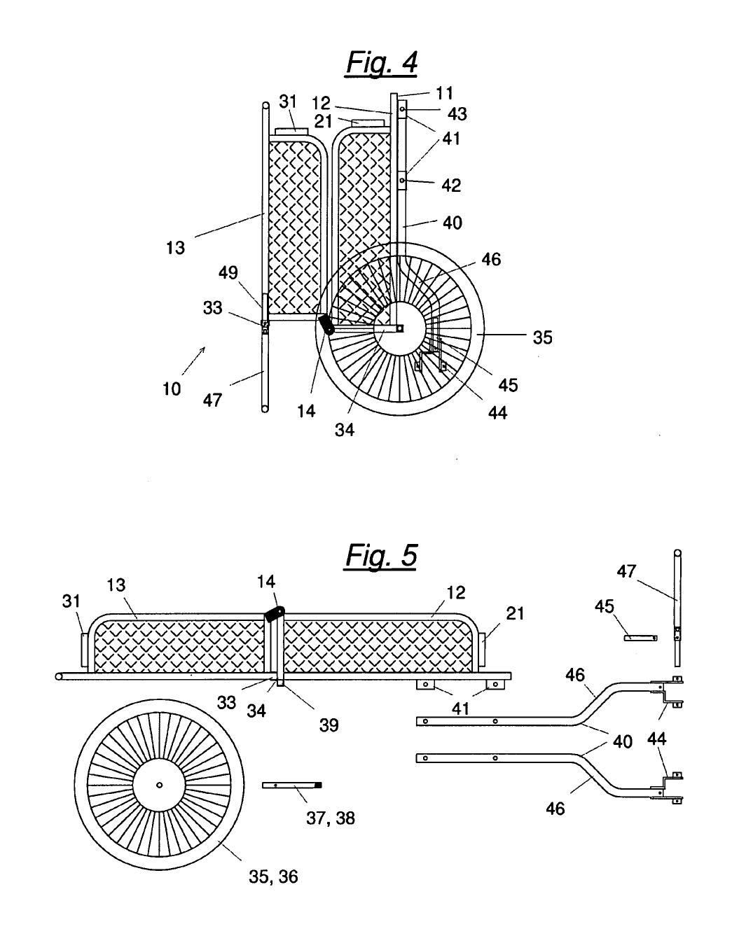

FIG. 4 shows a vertical compact storage position for the transport cart 10. In this position, the handle member 47 is removably nested within a corresponding structure 49 of the rear section 13 of the frame assembly 11. The handle member 47 is arranged to engage the ground surface and support the cart 10 in this vertical storage position. The wheels 35, 36 provide two other points of contact with the ground surface in this vertical storage position. This vertical storage position allows the cart 10 to be stored in a compact storage area, such as a closet or garage cabinet.

The folding transport cart 10 of the present invention can be used to perform a variety of tasks. For hunters, the cart will provide a handy vehicle for transporting harvested game, carrying equipment for walk-in hunting, and carrying goose and duck decoys, and so forth. For fishing, the cart will provide a convenient means for transporting fishing equipment and the day's catch, particularly for ice fishing. For camping, the cart can be used to transport camping gear, firewood, coolers, family games, and so forth. For yard maintenance, the cart can be used to transport plants, gardening tools, and yard waste, and can also be used to move soil, gravel, rocks and trash by placing a sheet of plastic or a tarp on the bottom. For farm use, the cart can be used to transport hay and equipment and to perform many other tasks, particularly in horse stables, tack and saddle sheds, barns, calving and lambing sheds, kennels, and the like. When it is not being used, the folding and nesting features of the cart will allow the cart to be transformed into a compact configuration and stored in small storage areas.

It will be appreciated that certain features of the present invention described herein will have utility separate from the combined assembly in which they are disclosed. For example, the convertible hitch assembly described herein can be used with a transport cart that does not fold or otherwise transform into a compact configuration.

While the invention has been described in connection with specific embodiments thereof, it is to be understood that this is by way of illustration and not of limitation, and the scope of the appended claims should be construed as broadly as the prior art will permit.

What is claimed is:

1. A folding transport cart, comprising:
a frame assembly having a front section, a rear section, and a hinge connecting the front and rear sections together for movement between a compact folded position for storage and an unfolded position for use;
a pair of support wheels attached to the frame assembly and disposed on right and left sides of the frame assembly for supporting the frame assembly above the ground; and
a hitch tongue removably attached to the front section of the frame assembly.

2. The folding transport cart according to claim 1, wherein
said front section of the frame assembly comprises a first platform and a first pair of upstanding walls on the right and left sides of the first platform;
said rear section of the frame assembly comprises a second platform and a second pair of upstanding walls on the right and left sides of the second platform; and
said hinge connects the front and rear sections together for pivotal movement about a transverse axis disposed above the first and second platforms.

3. The folding transport cart according to claim 2, wherein a front end of the second platform abuts against a rear end of the first platform at a location spaced below said hinge when the frame assembly is in its unfolded position.

4. The folding transport cart according to claim 2, further comprising first and second receptacles near front and rear ends of the front and rear sections of the frame assembly, respectively, for receiving planar members to provide upstanding front and rear end walls for the frame assembly.

5. The folding transport cart according to claim 1, wherein said pair of support wheels are attached to respective spindles secured to the front section of the frame assembly near a rear end of the front section.

6. The folding transport cart according to claim 1, wherein said hitch tongue comprises a vertical offset portion along its length, and said hitch tongue is connectable to the front section of the frame assembly in a first position to provide a low hitch towing arrangement, and a second position 180 degrees apart from the first position to provide a high hitch towing arrangement, wherein a hitch structure at a front end of the hitch tongue is positioned higher in the second position of the hitch tongue than in the first position of the hitch tongue.

7. The folding transport cart according to claim 6, wherein said hitch tongue is connectable into a third stowed position with the hitch tongue reversed from front to rear relative to the first and second positions such that the hitch structure is positioned behind the front side of the front section of the frame assembly.

8. The folding transport cart according to claim 1, further comprising a handle member removably attached to a pin opening at a front end of the hitch tongue to facilitate manual towing.

9. The folding transport cart according to claim 8, wherein said handle member is removably nested within the hitch tongue for providing a compact storage configuration when the handle member is not being used for manual towing.

10. The folding transport cart according to claim 8, wherein said handle member is removably nested within a corresponding structure of the rear section of the frame assembly and arranged to engage the ground surface and support the cart in a vertical storage position when the handle member is not being used for manual towing.

11. The folding transport cart according to claim 8, wherein said handle member has a generally T-shaped configuration.

12. A folding transport cart, comprising:
a frame assembly having a front section comprising a first platform, a rear section comprising a second platform, and a hinge connecting the front and rear sections together about a transverse axis disposed above the first and second platforms for movement between a compact folded position for storage and an unfolded position for use;
a pair of support wheels attached to the frame assembly and disposed on right and left sides of the frame assembly for supporting the frame assembly above the ground; and
a hitch tongue removably attached to the front section of the frame assembly.

13. The folding transport cart according to claim 12, wherein said front and rear sections each have upstanding walls on right and left sides thereof, and upper ends of said upstanding walls on the front section are pivotally coupled to upper ends of said upstanding walls on the rear section by said hinge.

14. The folding transport cart according to claim 13, wherein a front end of the second platform abuts against a rear end of the first platform at a location spaced below said hinge when the frame assembly is in its unfolded position.

15. The folding transport cart according to claim 12, wherein said hitch tongue comprises a vertical offset portion along its length, and said hitch tongue is connectable to the front section of the frame assembly in a first position to provide a low hitch towing arrangement and a second position to provide a high hitch towing arrangement, said first position being angularly offset 180 degrees about a longitudinal axis relative to said second position, wherein a hitch structure at a front end of the hitch tongue is positioned higher in the second position of the hitch tongue than in the first position of the hitch tongue.

16. The folding transport cart according to claim 15, wherein said hitch tongue is connectable into a third stowed position with the hitch tongue reversed from front to rear relative to the first and second positions such that the hitch structure is positioned behind the front side of the front section of the frame assembly.

17. The folding transport cart according to claim 12, further comprising a handle member removably attached to a pin opening at a front end of the hitch tongue to facilitate manual towing, wherein said hitch tongue has a first receptacle in its rear end in which said handle member can be stored when the handle member is not being used for manual towing, and wherein said rear section of the frame assembly has a second receptacle in its front end in which said handle member can be placed to support the cart in a vertical storage position.

18. A transformable hitch assembly, comprising:
a hitch tongue having front and rear ends, a hitch structure provided at said front end for connecting to a towing vehicle, and a structure for removably connecting the hitch tongue to a transport cart; and
a handle member removably attached to a pin opening at a front end of the hitch tongue to facilitate manual towing, wherein said hitch tongue has a first receptacle in its rear end in which said handle member can be stored when the handle member is not being used for manual towing.

19. The transformable hitch assembly according to claim 18, wherein said hitch tongue comprises a vertical offset portion along its length, said hitch tongue being connectable to a transport cart in a first position to provide a low hitch towing arrangement and a second position to provide a high hitch towing arrangement, said first position being angularly offset 180 degrees about a longitudinal axis relative to said second position, wherein said hitch structure at a front end of the hitch tongue is positioned higher in the second position of the hitch tongue than in the first position of the hitch tongue.

20. The transformable hitch assembly according to claim 19, wherein said hitch tongue is connectable into a third stowed position with the hitch tongue reversed from front to rear relative to the first and second positions, and wherein said transport cart has a second receptacle in which said handle member can be placed to support the cart in a vertical storage position.
